(19) United States
(12) Patent Application Publication
(10) Pub. No.: US 2026/0246183 A1
(43) Pub. Date: Aug. 20, 2026

(54) BOARD CONNECTOR

(71) Applicant: Yazaki Corporation, Tokyo (JP)

(72) Inventor: Hikaru Anma, Shizuoka (JP)

(73) Assignee: Yazaki Corporation, Tokyo (JP)

(21) Appl. No.: 19/536,983

(22) Filed: Feb. 11, 2026

(30) Foreign Application Priority Data
Feb. 19, 2025 (JP) 2025-025116

(51) Int. Cl. H01R 13/41; H01R 13/506

(52) U.S. Cl. CPC H01R 13/41; H01R 13/506

(57) ABSTRACT

A board connector includes an inner terminal, an inner housing, an outer terminal, a shield shell, an outer housing, and a lid member. At a lower portion of the shield shell to which the inner housing is assembled, a cutout for a guide rail is formed, and a rib formed on the inner housing is inserted through the cutout.

### CROSS-REFERENCE TO RELATED APPLICATIONS

The present application is based on, and claims priority from the prior Japanese Patent Application No. 2025-025116, filed on February 19, 2025, the entire contents of which are incorporated herein by reference.

### TECHNICAL FIELD

The present disclosure relates to a board connector.

### BACKGROUND

In the related art, for example, there has been known a board connector that is installed on a circuit board. JP 2023-77187 A discloses a technique relating to a board connector including a terminal, a shield member for noise reduction, and an outer housing that holds the terminal and the shield member. In the board connector, the terminal includes a contact portion that extends to a front side, and a mounting portion that extends toward a mounting surface of the circuit board and is connected to the circuit board. Further, the shield member includes a front wall portion that separates the mounting portion from a fitting portion of the outer housing, a top wall portion that sandwiches the mounting portion between the top wall portion and the mounting surface, and a pair of side wall portions that sandwich the mounting portion in a width direction. The front wall portion, the top wall portion, and the side wall portions define an accommodation space that accommodates the terminal. The mounting portion includes a bulging portion at which the mounting portion bulges in a fitting direction in at least a part thereof. A bulging portion is provided at the mounting portion of the terminal at which the mounting portion bulges in the fitting direction. By adjusting a shape or the like of the bulging portion of the mounting portion, dielectric characteristics of the terminal can be adjusted.

### SUMMARY OF THE INVENTION

Regarding the press-fitting of the inner housing, the inner housing is press-fitted coaxially with the outer terminal, and the shield shell in the related art is covered with the outer terminal and exhibits a shielding function. However, even when the inner housing is press-fitted coaxially with the outer terminal, the inner housing is not fixed with respect to a right-and-left direction, and there is a possibility that the inner housing may rattle.

An object of the present disclosure is to provide a board connector capable of suppressing rattling of an inner housing assembled to a shield shell.

A board connector according to an embodiment includes an inner terminal that is electrically connected to a circuit board, and contacts with a mating inner terminal of a mating connector, an inner housing that includes an accommodation portion accommodating the inner terminal, an outer terminal that covers a part of the inner terminal, is electrically connected to the circuit board, and contacts with a mating outer terminal of the mating connector, a shield shell that includes a holding hole portion through which the outer terminal passes for holding the outer terminal, an outer housing that accommodates and holds the outer terminal and the shield shell, and a lid member that is assembled to the shield shell. At a lower portion of the shield shell to which the inner housing is assembled, a cutout for a guide rail is formed, and a rib formed on the inner housing is inserted through the cutout.

According to the above-mentioned configuration, it is possible to provide a board connector a board connector capable of suppressing rattling of an inner housing assembled to a shield shell.

### BRIEF DESCRIPTION OF DRAWINGS

FIG. 1 is a perspective view illustrating a state in which a board connector according to the present embodiment is mounted on a circuit board.

FIG. 2 is a perspective view of the board connector.

FIG. 3 is an exploded perspective view of the board connector.

FIG. 4 is a side cross-sectional view of the board connector.

FIG. 5 is a back view of the board connector in a state in which an inner terminal at an upper stage and an inner housing are removed, as viewed from a rear side.

FIG. 6 is an enlarged view of Part A of FIG. 5.

FIG. 7 is a side view of an inner terminal at a lower stage.

FIG. 8 is a back view an inner housing at a lower stage as viewed from a rear side.

FIG. 9 is a cross-sectional view taken along the line B-B of FIG. 8.

FIG. 10 is a back view an outer terminal as viewed from a rear side.

FIG. 11 is a cross-sectional view taken along the line C-C of FIG. 10.

FIG. 12 is a side view of the outer terminal.

FIG. 13 is a back view a shield shell as viewed from a rear side.

FIG. 14 is a cross-sectional view taken along the line D-D of FIG. 13.

FIG. 15 us a front view of the shield shell as viewed from a front side.

FIG. 16 is a back view of an outer housing as viewed from a rear side.

FIG. 17 is a cross-sectional view taken along the line E-E of FIG. 16.

FIG. 18 is a front view of the outer housing as viewed from a front side.

FIG. 19 is a back view of a lid as viewed from a rear side.

FIG. 20 is a view for describing assembling of the inner housing to the shield shell.

FIG. 21 is a view for describing assembling of the inner housing to the shield shell.

### DETAILED DESCRIPTION OF THE INVENTION

With reference to the drawings, a board connector according to the present embodiment is described below in detail. Note that the dimensional ratios in the drawings are exaggerated for explanatory purposes, and may differ from the actual ratios.

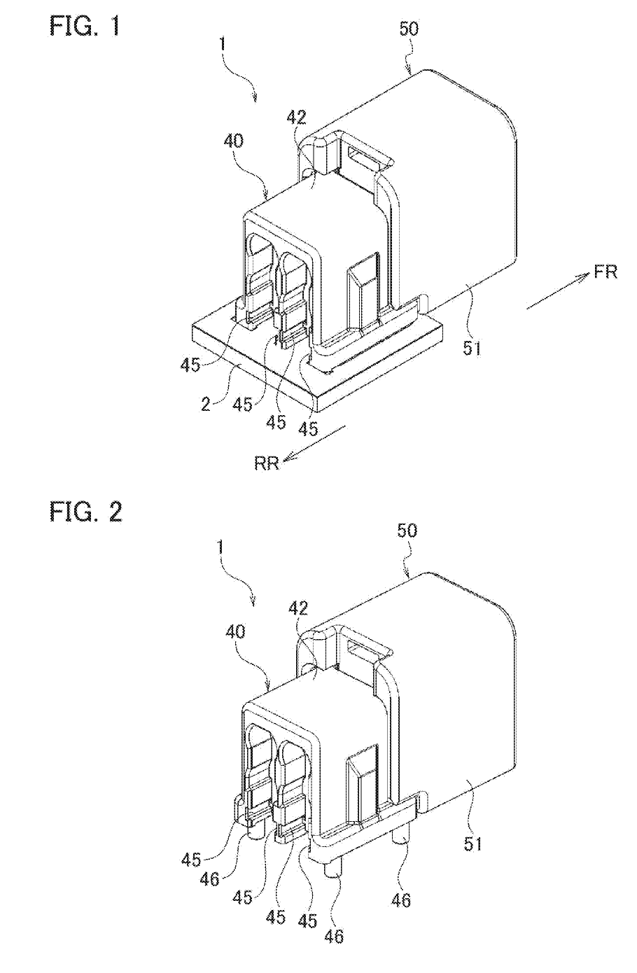

As illustrated in FIG. 1, a board connector 1 according to the present embodiment is a male connector for high frequency use, which is also referred to as a printed circuit board (PCB) connector, and can be fitted into a mating connector (female connector) omitted in illustration.

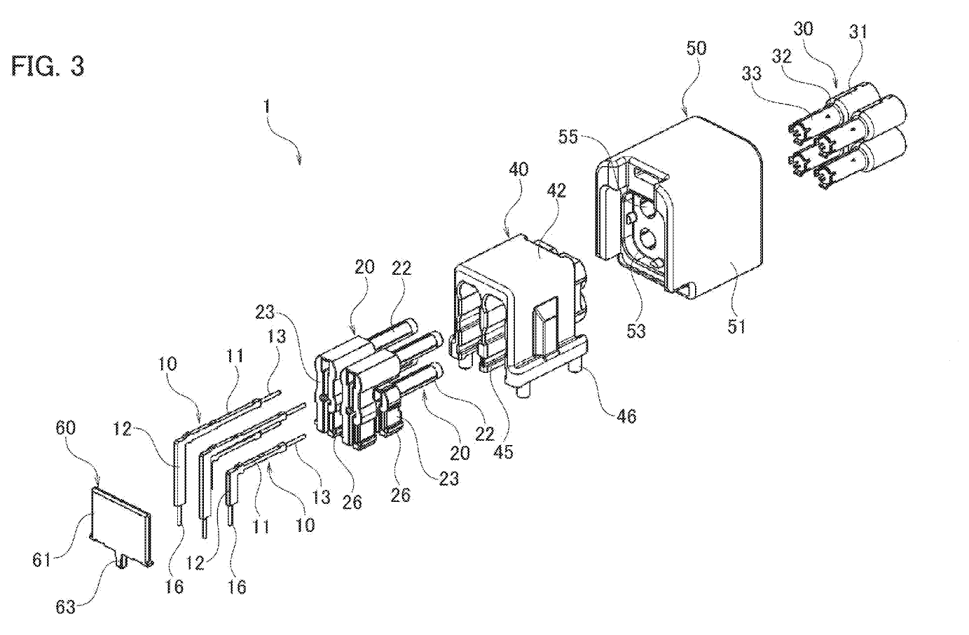

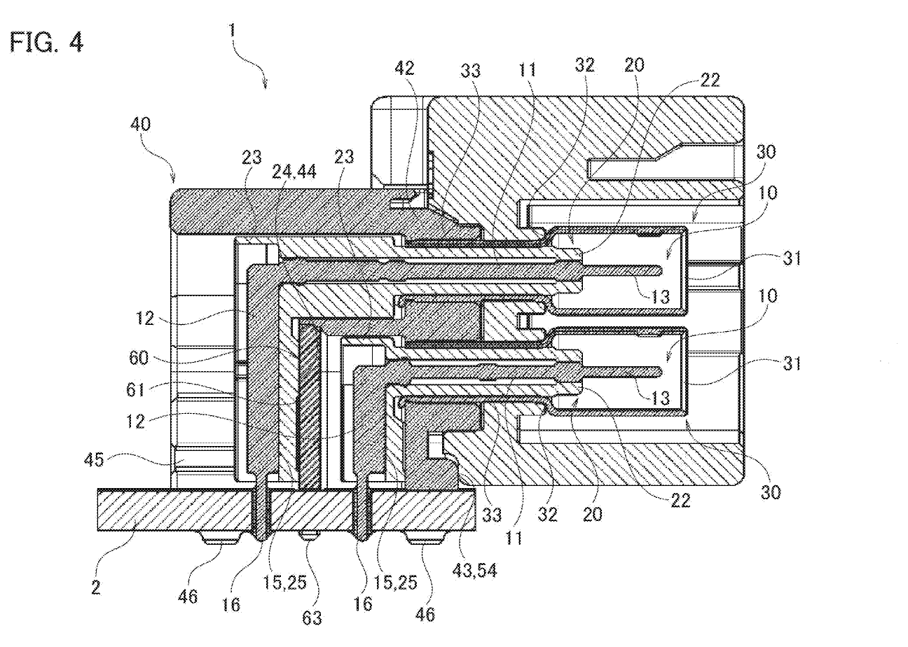

As illustrated in FIG. 1 to FIG. 6, the board connector 1 includes an inner terminal 10, an inner housing 20, an outer terminal 30, a shield shell 40, an outer housing 50, and a lid member (lid 60). The board connector 1 is mounted on a circuit board 2 and used (see FIG. 1). In the present embodiment, an opening side of the outer housing 50 is referred to as the front side FR, and the circuit board 2 side thereof is referred to as a rear side RR.

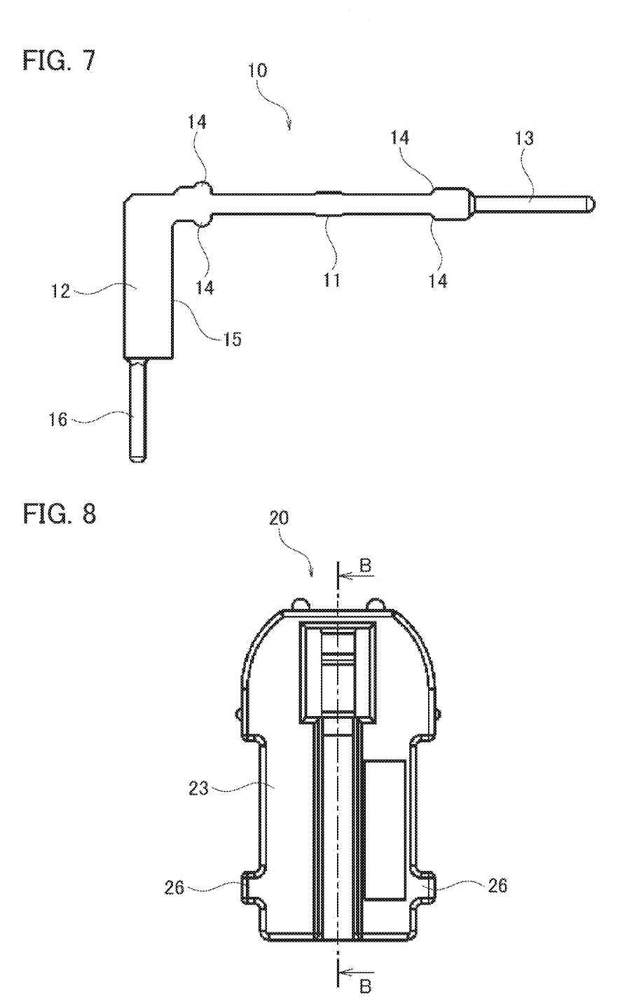

The inner terminal 10 illustrated in FIG. 7 is electrically connected to the circuit board 2, and contacts with a mating inner terminal of the mating connector (omitted in illustration). The inner terminal 10 is also referred to as an inner conductor. In the present embodiment, the inner terminals 10 are arranged in two vertical stages, with two being arranged at an upper stage and two being arranged at a lower stage.

As illustrated in FIG. 7, the inner terminal 10 at the lower stage is formed into a bar-like shape of metal or the like, includes a main body portion 11 and a hanging portion 12, and is formed into an L-like shape. The main body portion 11 is accommodated in an accommodation portion 21 of the inner housing 20. A distal end portion 13 of the main body portion 11 contacts with the mating inner terminal (omitted in illustration), and is conducted therewith. A press-fit protrusion 14 is formed at the main body portion 11. A plurality of (four in the present embodiment) press-fit protrusions 14 are formed at the main body portion 11, and are provided so that the inner terminal 10 is press-fitted into the accommodation portion 21 of the inner housing 20. The hanging portion 12 extends downward from a rear end portion of the main body portion 11. At an end surface of the hanging portion 12 on the front side FR, an abutting surface 15 that abuts against the inner housing 20 at the time of assembly of the inner terminal 10 is formed. At a lower end portion of the hanging portion 12, a connection portion 16 is formed. The connection portion 16 contacts with the circuit board 2, and is conducted therewith. The connection portion 16 is inserted into a through hole formed in the circuit board 2, and is fixed thereto via solder.

Although the inner terminal 10 at the upper stage differs in length from the inner terminal 10 at the lower stage, their structures are similar, and thus detailed description thereof is omitted.

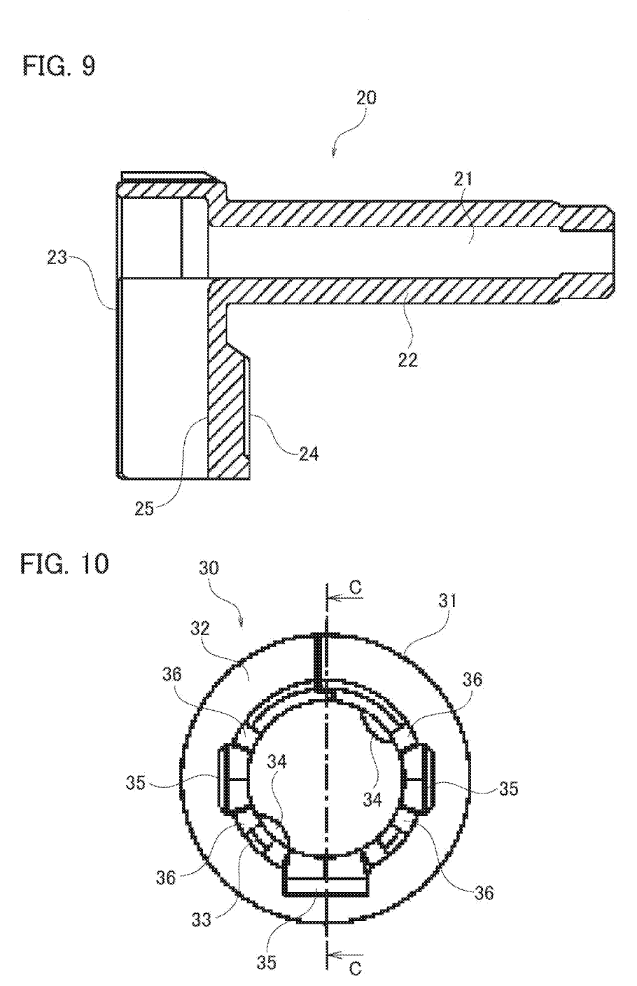

As illustrated in FIG. 8 and FIG. 9, the inner housing 20 includes the accommodation portion 21 that accommodates the inner terminal 10. The inner housings 20 are arranged in two vertical stages, with two being arranged at an upper stage and two being arranged at a lower stage.

As illustrated in FIG. 8 and FIG. 9, the inner housing 20 at the lower stage is formed of a synthetic resin or the like, includes a main body portion 22 and a hanging portion 23, and is formed into an L-like shape. The main body portion 22 is formed into a tubular shape, and includes the accommodation portion 21 that accommodates the inner terminal 10. The main body portion 22 is accommodated in a small diameter portion 33 of the outer terminal 30. The hanging portion 23 performs positioning so as to connect the inner terminal 10 to the circuit board 2, and extends downward from a rear end portion of the main body portion 22. At a front surface of the hanging portion 23, an abutting surface 24 that abuts against the shield shell 40 is formed (see FIG. 9). Further, a rear portion of the hanging portion 23 is cut out so that the inner terminal 10 is accommodated, and an abutting surface 25 that abuts against the inner terminal 10 is formed at an end surface inside the hanging portion 23 being cut out (see FIG. 9). Further, on each of both the right and left sides of the hanging portion 23, a rib 26 for suppressing rattling when the inner housing 20 is assembled to the shield shell 40 is provided (see FIG. 8).

Although the inner housing 20 at the upper stage differs in length from the inner housing 20 at the lower stage, their structures are similar, and thus the detailed description thereof is omitted.

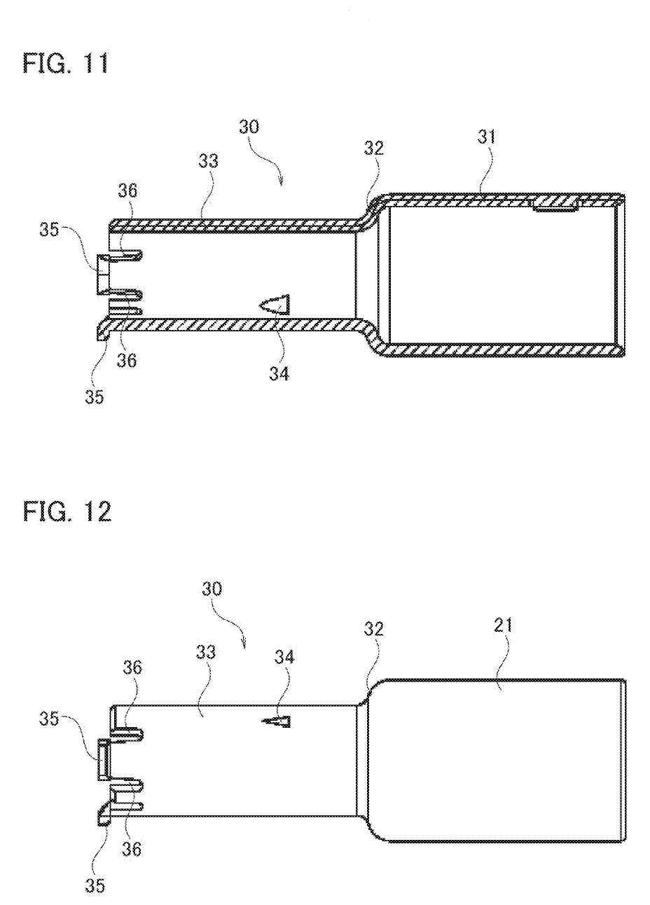

The outer terminal 30 illustrated in FIG. 10 to FIG. 12 covers a part of the inner terminal 10, is electrically connected to the circuit board 2, and contacts with a mating outer terminal of the mating connector (omitted in illustration). The outer terminal 30 is also referred to as an outer conductor. The outer terminals 30 are arranged in two vertical stages, with two being arranged at an upper stage and two being arranged at a lower stage.

As illustrated in FIG. 10 to FIG. 12, the outer terminal 30 is formed into a stepped cylindrical shape of metal or the like. The outer terminal 30 includes a large diameter portion 31, a joining portion 32, and the small diameter portion 33. The large diameter portion 31 contacts with the mating outer terminal (omitted in illustration), and is conducted therewith. The joining portion 32 is positioned between the large diameter portion 31 and the small diameter portion 33 is positioned by abutting against the outer housing 50. The small diameter portion 33 is a portion in which the inner housing 20 is accommodated. At the small diameter portion 33, a plurality of locking portions 34 are formed by cutting and raising so as to lock the inner housing 20. At a terminal end portion (the end portion on the rear side RR) of the small diameter portion 33, a locking piece portion 35 that is bent in advance is formed. A slit 36 is formed on each of the both sides of the locking piece portion 35.

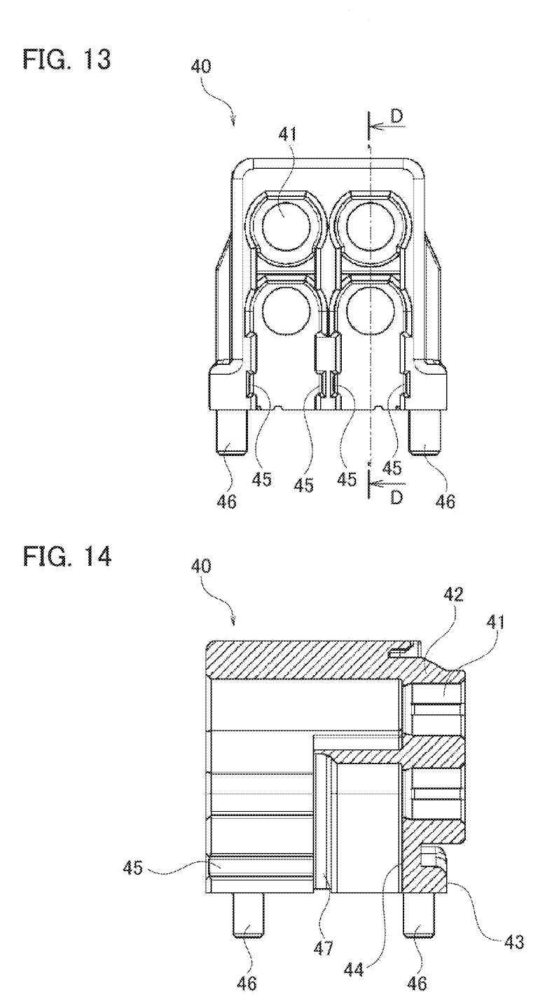

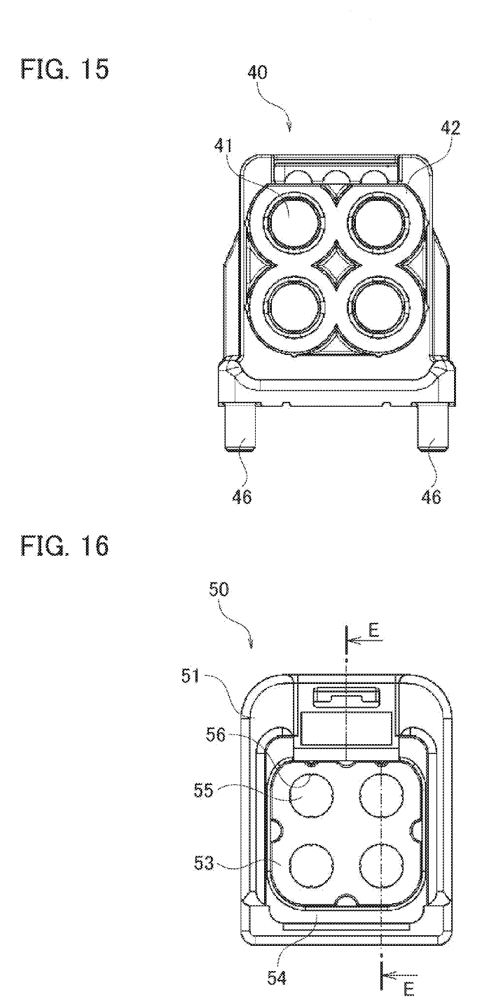

The shield shell 40 illustrated in FIG. 13 to FIG. 15 includes a holding hole portion 41 through which the outer terminal 30 passes for holding the outer terminal 30. The shield shell 40 is formed of metal or the like.

As illustrated in FIG. 13 to FIG. 15, the shield shell 40 includes a front portion 42 that is assembled to the outer housing 50 and the holding hole portion 41 in which the outer terminal 30 is accommodated. At an end surface of the front portion 42, an abutting surface 43 that abuts against the outer housing 50 is formed (see FIG. 14). At an end surface of the holding hole portion 41, an abutting surface 44 that abuts against the inner housing 20 is formed (see FIG. 14). Further, at a groove lower portion assembled to the inner housing 20, cutouts 45 for a guide rail are formed as a pair on right and left sides, and the rib 26 of the inner housing 20 can be inserted through the cutout 45. At the shield shell 40, a plurality of (four in the present embodiment) leg portions 46 that protrude downward from a lower surface of the shield shell 40 are formed. The leg portion 46 is electrically connected to the circuit board 2. The leg portion 46 is inserted into a through hole formed in the circuit board 2, and is fixed thereto via solder. Further, in the lower surface of the shield shell 40 at which the leg portion 46 is formed, an accommodation portion 47 for assembling and accommodating the lid 60 is formed to be opened.

The outer housing 50 illustrated in FIG. 16 to FIG. 18 accommodates and holds the outer terminal 30 and the shield shell 40.

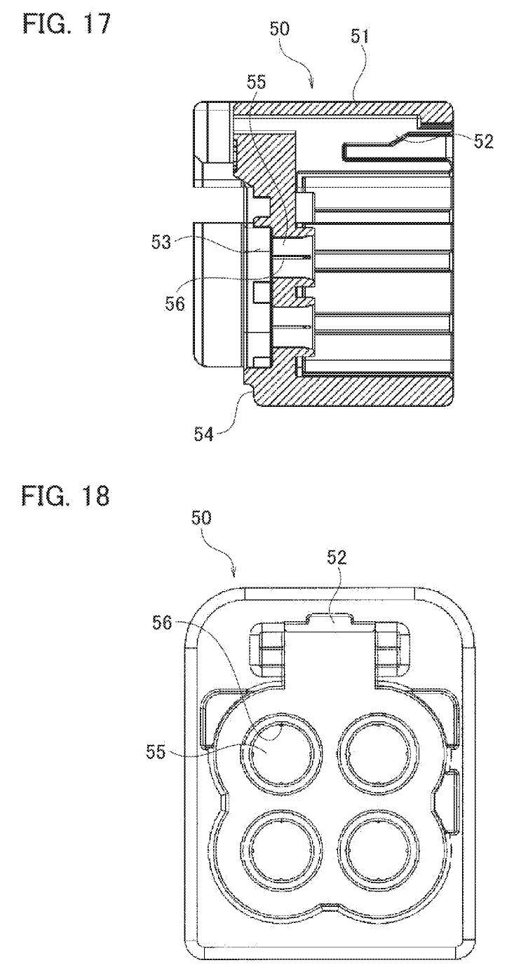

As illustrated in FIG. 16 to FIG. 18, the outer housing 50 includes a main body portion 51 formed of a synthetic resin or the like. At an upper part of the main body portion 51, a lock beak 52 that locks the mating connector (omitted in illustration) is formed. Inside the main body portion 51, the accommodation chamber 53 that accommodates the front portion 42 of the shield shell 40 is formed, and an abutting surface 54 that abuts against the shield shell 40 is formed at an end surface of the accommodation chamber 53 (see FIG. 17). Further, inside the main body portion 51, an accommodation hole portion 55 is formed for assembling the outer terminal 30, and a cylindrical projection portion 56 against which the outer terminal 30 abuts is formed on an inner periphery of the accommodation hole portion 55. The accommodation hole portions 55 are arranged in two vertical stages, with two being arranged at an upper stage and two being arranged at a lower stage. In the present embodiment, a plurality of (four in the present embodiment) cylindrical projection portions 56 are formed at an interval in the circumferential direction.

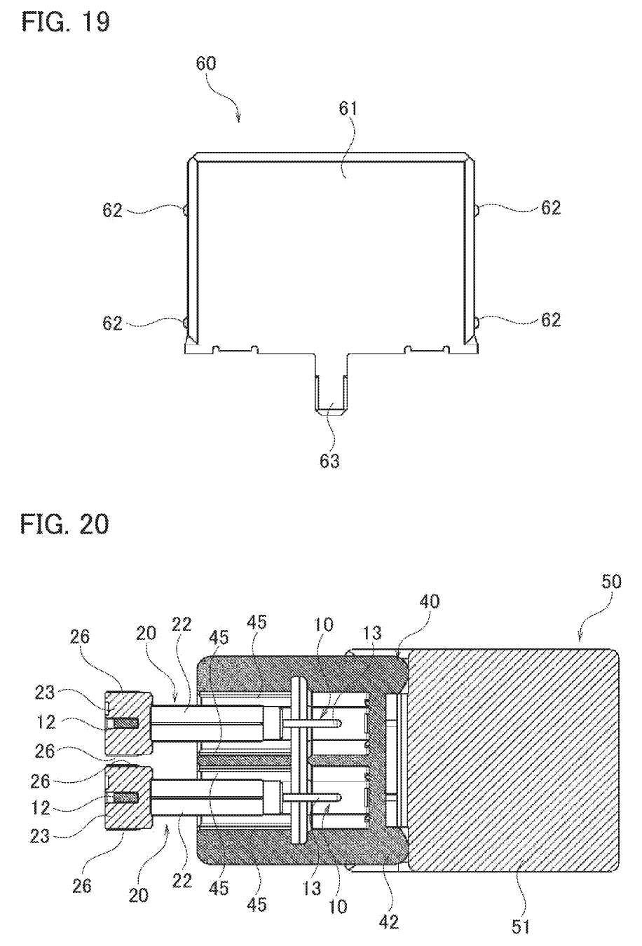

The lid 60 illustrated in FIG. 19 is assembled to the shield shell 40.

As illustrated in FIG. 19, the lid 60 is assembled to the shield shell 40, and includes a function of partitioning the inside of the shield shell 40 into the front part and the rear part. The lid 60 includes a lid main body 61 formed into a plate-like shape of a metal or the like. A press-fit protrusion 62 is formed on each of the right and left sides of the lid main body 61. The press-fit protrusion 62 is provided so that the lid 60 is press-fitted into and assembled to the accommodation portion 47 of the shield shell 40. At the lid main body 61, a leg portion 63 that protrudes downward from a lower end surface of the lid main body 61 is formed. The leg portion 63 is inserted into a through hole corresponding to an earth portion of a conductor pattern formed on the circuit board 2, and is fixed thereto via solder.

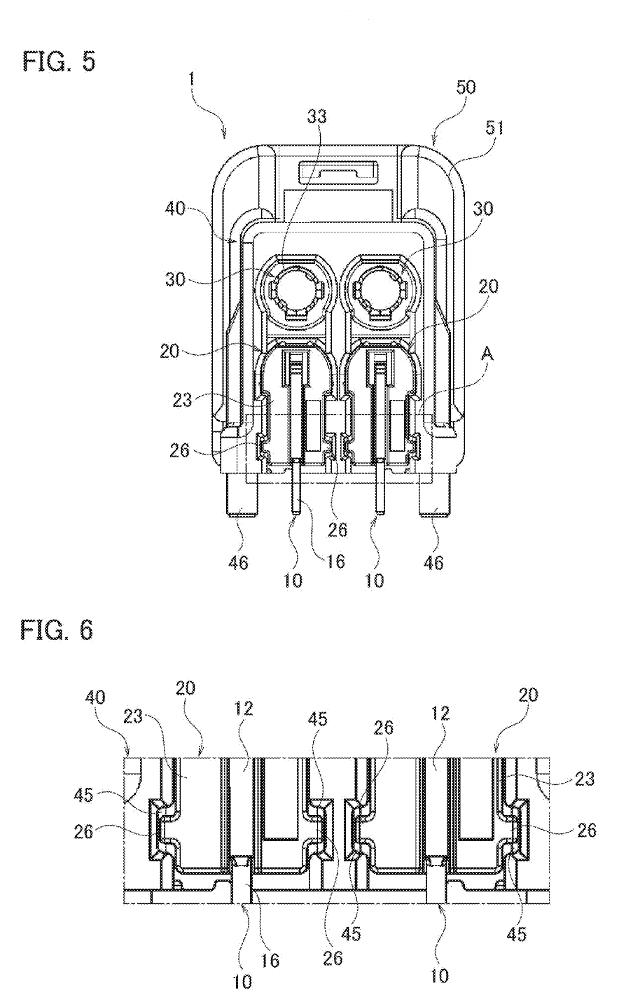

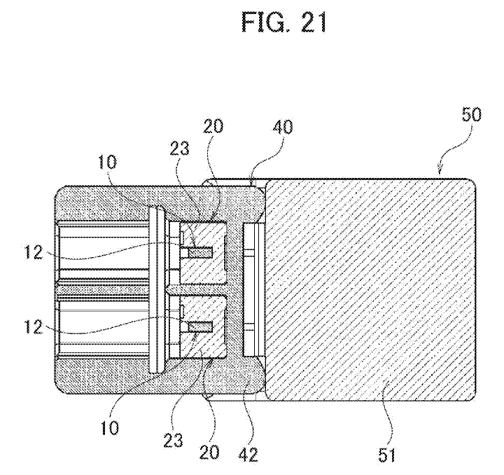

As illustrated in FIG. 20 and FIG. 21, the inner housing 20 is assembled to the shield shell 40. In this state, the rib 26 of the inner housing 20 is inserted through the cutout 45 of the groove lower portion of the shield shell 40, and thus rattling of the inner housing 20 can be suppressed (see FIG. 5 and FIG. 6). The distal end of the rib 26 and the cutout 45 may abut against each other, and there may be no interval between the distal end of the rib 26 and the cutout 45. Alternatively, there may be a slight interval between the distal end of the rib 26 and the cutout 45.

As described above, the board connector 1 according to an aspect of the present embodiment includes the inner terminal 10 that is electrically connected to the circuit board 2, and contacts with the mating inner terminal of the mating connector, and the inner housing 20 that includes the accommodation portion 21 accommodating the inner terminal 10. The board connector 1 includes the outer terminal 30 that covers a part of the inner terminal 10, is electrically connected to the circuit board 2, and contacts with the mating outer terminal of the mating connector, and the shield shell 40 that includes the holding hole portion 41 through which the outer terminal 30 passes for holding the outer terminal 30. The board connector 1 includes the outer housing 50 that accommodates and holds the outer terminal 30 and the shield shell 40, and the lid member (the lid 60) that is assembled to the shield shell 40. At the lower portion (groove lower portion) of the shield shell 40 to which the inner housing 20 is assembled, the cutout 45 for a guide rail is formed, and the rib formed on the inner housing 20 is inserted through the cutout 45.

By providing the rib 26 on the inner housing 20, rattling of the inner housing 20 when the inner housing 20 is assembled to the shield shell 40 can be suppressed. Further, by providing the cutout 45 on the shield shell 40, the cutout 45 can serve as a guide rail, and impedance can be adjusted to stabilize transmission performance.

According to the present embodiment described above, it is possible to provide the board connector 1 capable of suppressing rattling of the inner housing 20 assembled to the shield shell 40.

In the board connector 1, the cutout 45 may be formed on each of both the right and left sides to form a pair, and the rib 26 may be formed on each of both the right and left sides of the inner housing 20.

Thus, by providing the cutout 45 on the shield shell 40, the cutout 45 can serve as a guide rail, and impedance can be adjusted to stabilize transmission performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A board connector comprising:
an inner terminal that is electrically connected to a circuit board, and contacts with a mating inner terminal of a mating connector;
an inner housing that includes an accommodation portion accommodating the inner terminal;
an outer terminal that covers a part of the inner terminal, is electrically connected to the circuit board, and contacts with a mating outer terminal of the mating connector;
a shield shell that includes a holding hole portion through which the outer terminal passes for holding the outer terminal;
an outer housing that accommodates and holds the outer terminal and the shield shell; and
a lid member that is assembled to the shield shell, wherein
at a lower portion of the shield shell to which the inner housing is assembled, a cutout for a guide rail is formed, and a rib formed on the inner housing is inserted through the cutout.

2. The board connector according to claim 1, wherein
the cutout is formed on each of both right and left sides to form a pair, and the rib is formed on each of both right and left sides of the inner housing.
